(19) United States
(12) Patent Application Publication
(10) Pub. No.: US 2006/0012301 A1
(43) Pub. Date: Jan. 19, 2006

(54) Vacuum getter chamber

(76) Inventor: Frank Yang, Guanyin Township (KR)

Correspondence Address: Yi-Wen Tseng, 4331 Stevens Battle Lane, Fairfax, VA, 22033, US

(21) Appl. No.: 10/892,218

(22) Filed: Jul. 16, 2004

(51) Int. Cl. H01J 17/24; H01J 61/26

(52) U.S. Cl. 313/561; 313/553; 313/545; 313/549; 313/495

(57) ABSTRACT

A structure of a vacuum getter chamber allocated on a panel of a flat panel display includes more than one aperture, a getter located on the panel between the apertures, a vacuum getter structure disposed on the panel to cover the getter and the apertures. The vacuum getter structure has a recess to form a getter chamber. The surface of the vacuum getter has a hole in communication with the chamber. During vacuuming process, the getter forms a chemical vacuum status in the vacuum chamber, such that a sufficient vacuum level is formed between a cathode electrode and an anode electrode of the panel. Thereby, an electron beam generated from the cathode electrode can impinge the phosphor of the anode electrode within a cavity to generate light.

### BACKGROUND OF THE INVENTION

The present invention relates in general to a structure of a vacuum getter chamber, and more particularly, to a vacuum getter chamber using a new getter installed in a vacuum getter structure, so as to provide a sufficient vacuum level during vacuuming process. Thereby, the electron beam generated from the cathode electrode can impinge phosphor of the anode electrode within a cavity to generate light.

The conventional vacuum display such as the vacuum fluorescent display (VFD) as disclosed in U.S. Pat. No. 5,635,795, cathode ray tube (CRT), field-emission display (FED) as disclosed in U.S. Pat. No. 6,084,344 provides a vacuum cathode in which a free path is formed allowing an electron beam generated from a cathode electrode to propagate, so as to impinge the phosphor of an anode electrode to generate light.

The vacuum level of the above vacuum display is typically kept at 10⁻⁵ to 10⁻⁷ torr. Although the vacuum level of cavity can be maintained by packaging the cavity, leakage is still unavoidable. The source of the leakage includes the package material, the internal material of the vacuum device such as the coating of the cathode and anode electrodes, electron-emission source, and phosphor, for example. The leakage source during operation includes the heat of phosphor excited by the electron beam. Such type of leakage may even poison the material of the electron-emission source or the phosphor to affect the luminescent efficiency.

Therefore, to maintain the vacuum level of the cavity, a getter box has been installed in the vacuum chamber, and a getter is disposed in the vacuum chamber. The getter is normally composed of barium compound. By activation process, pure barium can be released to attach to a large area of the getter chamber, such that the leakage can be absorbed by the pure barium effectively.

The activation process for barium has to be performed at a temperature higher than 700° C., and the barium has to be disposed at a specific area. Therefore, to avoid affecting or activating other members such as the electron-emission source or the phosphor, the barium is located at a place remote to the effective display area. As a result, the ineffective area of the display is increased; and consequently, the available display area is reduced.

### BRIEF SUMMARY OF THE INVENTION

Brand new vacuum getter structure and getter are provided to provide gas guide, so as to reduce vacuuming time, cost and the total thickness. Therefore, the overall thickness of the display can be minimized, and the insufficient vacuum level at the corner of the flat-panel structure can also be resolved. Further, the vacuum getter structure can be used as a reinforcing rib of the display, such that the strength of the cathode panel structure is increased. This is advantageous in fabricating a large-area flat panel display. Further, the glass cracking problem caused by local high temperature during the tip-off process can be overcome. In addition, the locations for disposing the getter are reduced to increase vacuum level. As the activation temperature of the getter is relatively lower, the internal materials of the display will not be affected by the activation process. Therefore, the ineffective display area is reduced.

Accordingly, a flat panel display provided by the present invention includes a display member, a getter and a chamber. The display member has an anode plate and a cathode plate forming a chamber therebetween, wherein the cathode plate includes at least two apertures extending therethough. The getter is distributed on a first surface of the cathode plate between the apertures. Moreover, the chamber member is mounted on the cathode plate to form a getter chamber, the chamber member covering the apertures and the getter therein.

### BRIEF DESCRIPTION OF THE DRAWINGS

The above objects and advantages of the present invention will be become more apparent by describing in detail exemplary embodiments thereof with reference to the attached drawings in which:

FIG. 1 is perspective view of a vacuum getter structure;

FIG. 2 is a side view of the vacuum getter structure;

FIG. 3 shows the application of the vacuum getter structure to a panel of a flat panel display;

FIG. 4 illustrates assembly of the vacuum getter structure and the panel of the flat panel display; and

FIG. 5 shows a cross sectional view of FIG. 4.

### DETAILED DESCRIPTION OF THE INVENTION

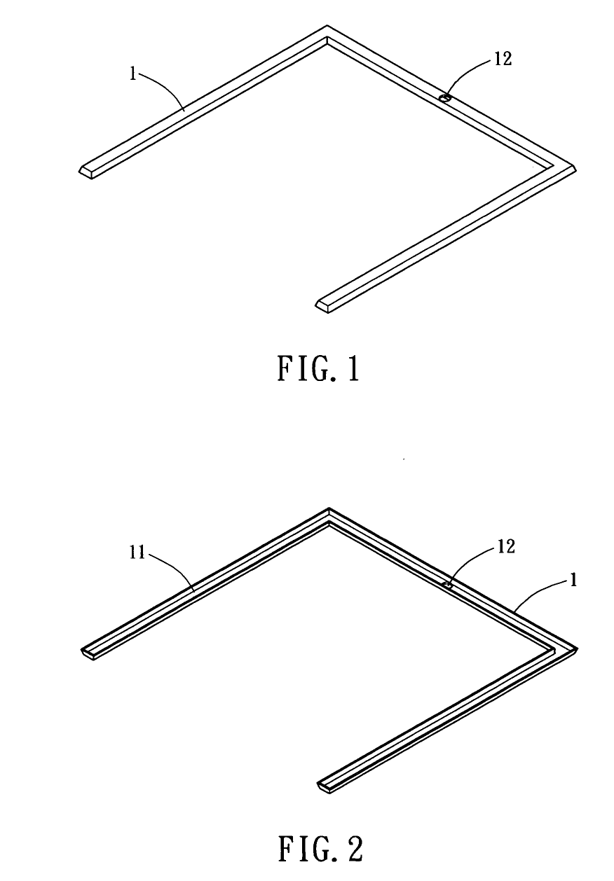

Referring to FIGS. 1 and 2, as provided, the vacuum getter structure is applied to a panel of a flat panel display such as a field-emission display to provide is a vacuum getter structure, in which a free path is established after vacuuming process. Therefore, an electron beam generated by the cathode electrode of the panel can propagate along the free path to impinge the phosphor of the anode electrode.

The vacuum getter chamber 1 is formed by thermal pressing a flat panel glass. Alternatively, glass paste ejection is used to form a curved stripe structure or a flat-panel structure. The internal surface of the vacuum getter chamber 1 is recessed upwardly to form a getter chamber 11. The vacuum getter chamber 1 has a hole 12 in communication with the getter chamber 11.

The space encompassed by the getter chamber 11 and the cathode plate (not shown) has a vertical depth, preferably but optionally, larger than 2.5 millimeters to provide good gas conduction coefficient.

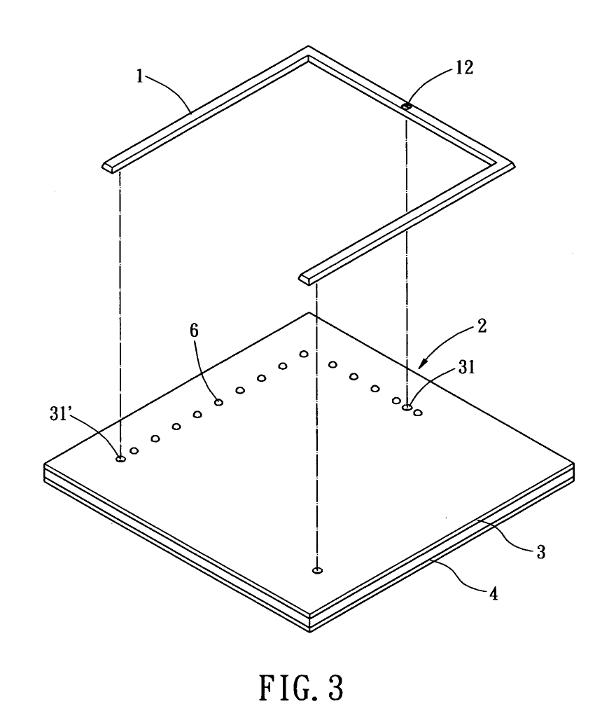

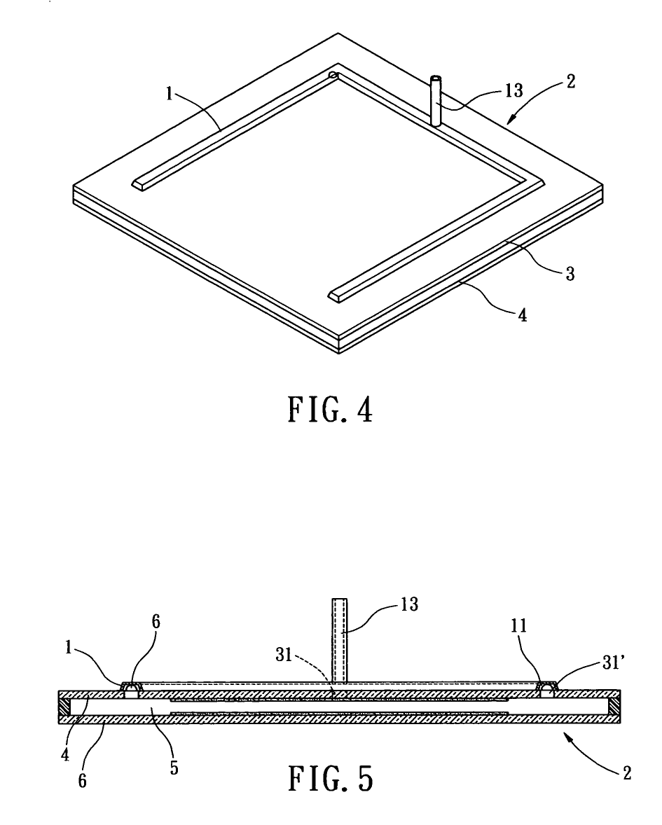

Referring to FIGS. 3 to 5, the vacuum getter structure 1 and the panel 2 are connected together, and vacuum process is performed. A plurality of apertures 31 is formed on the cathode plate 3 of the panel 2. The apertures 31 extend through the cathode plate 3 to form channels communicating the getter chamber 11 and a space between the cathode plate 3 and the anode plate 4. The getter 6 is distributed between the apertures 31 and 31 along the vacuum getter structure 1. Preferably but optionally, the getter 6 is discretely arranged along the getter chamber 11. In this embodiment, barium alloy St22 provided by SAES is used as the getter 6 because its activation temperature is about 450° C. In addition, the activated barium alloy will not generate large-area barium powders attached to the getter chamber 11. The configuration of the barium alloy can be designed according to the getter chamber or other gas collecting/absorbing metal.

The getter 6 is attached to the cathode plate 3 between the holes 31 and 31′ by glass glue. The vacuum getter structure 1 is then attached to the cathode plate 3 to cover the apertures 31 and the getter 6. A tube member 13 is installed at the hole 12 of the vacuum getter structure 1 to connect the getter chamber 11 to an external vacuum device. Thereby, a chemical vacuum state can be formed within the vacuum getter structure 1, and a free path is formed between the cathode plate 3 and the anode plate 4, such that an electron beam generated by the cathode plate 3 can propagate along the free path to impinge the phosphor of the anode plate 4 to generate light.

The above embodiment of vacuum getter structure has at least the following advantages:

1. The curved vacuum getter structure 1 provides gas guide to reduce vacuuming time, so as to reduce the cost.

2. The design of the getter chamber 11 minimizes the overall thickness of the flat panel display.

3. The elongate large-area gas collecting chamber resolves the problem of insufficient vacuum level at the corners.

4. The vacuum getter structure 1 is also functioning as structurally reinforcing rib, such that the elongate large-area gas collecting chamber enhances the strength of the cathode plate. Therefore, the glass cracking problem caused by local high temperature during tip-off process is overcome.

5. The function matches the long, thin type getter. The number of locations to distribute the getter is reduced. Therefore, the vacuum level can be enhanced. Further, as the thickness of the getter chamber is not limited to 2.5 mm, the thin and light requirement of the flat panel display will not be affected.

6. The getter is only disposed along the side of the cathode plate 3, and the activation temperature is low, such that the internal material will not be affected, and the available display area is increased.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A vacuum getter structure to be mounted to a flat panel display, comprising a cover to form a getter chamber between curved structure and a panel of the flat panel display, a getter distributed on the panel within the getter chamber and a hole extending through the cover.

2. The structure of claim 1, wherein the cover is formed by thermal pressing a flat glass panel.

3. The structure of claim 1, wherein the cover is formed by glass paste ejection.

4. The structure of claim 1, wherein the cover includes a curved strip member.

5. The structure of claim 1, wherein the cover includes a flat plate with an internal surface recessed upwardly.

6. The structure of claim 1, wherein the panel includes a cathode plate.

7. The structure of claim 6, wherein the flat panel display further comprising an anode plate opposing to the cathode plate, such that a chamber is formed between the cathode and anode plates.

8. The structure of claim 7, wherein the cathode plate includes at least two apertures to communicate the getter chamber and the chamber between the cathode and anode plates.

9. The structure of claim 8, wherein the apertures are covered by the cover.

10. The structure of claim 10, wherein the getter is distributed in various locations between the apertures within the getter chamber.

11. A flat panel display, comprising:
a display member, having an anode plate and a cathode plate forming a chamber therebetween, wherein the cathode plate includes at least two apertures extending therethough;
a getter, distributed on a first surface of the cathode plate between the apertures; and
a chamber member, mounted on the cathode plate to form a getter chamber, the chamber member covering the apertures and the getter therein.

12. The display of claim 11, further comprising a tube member communicating the getter chamber to a vacuum device.

13. The display of claim 12, wherein the chamber member includes a hole though which the tube member is connected to the getter chamber.

14. The display of claim 11, further comprising an electron-emission source formed on a second surface of the cathode plate.

15. The display of claim 11, further comprising a phosphor layer formed on the anode plate.

16. The display of claim 11, wherein the getter includes a barium alloy.

17. The display of claim 11, wherein the getter includes a barium alloy having an activation temperature about 450° C.

18. The display of claim 11, wherein the getter includes a material that will not be absorbed in a large area of the getter chamber after being activated.

20. The display of claim 11, wherein the chamber member is attached to the display member by glass glue.

21. The display of claim 11, wherein the getter chamber has a depth larger than about 2.5 millimeters.
